(19) United States
(12) Patent Application Publication
(10) Pub. No.: US 2017/0310178 A1
(43) Pub. Date: Oct. 26, 2017

(54) ROTOR BODY FOR A ROTATING ELECTRICAL MACHINE

(71) Applicant: SIEMENS AKTIENGESELLSCHAFT, Munich (DE)

(72) Inventors: Christian JÄKEL, Duisburg (DE); Matthias KOWALSKI, Mülheim an der Ruhr (DE); Omer MRKULIC, Dinslaken (DE)

(73) Assignee: Siemens Aktiengesellschaft, Munich (DE)

(21) Appl. No.: 15/517,304

(22) PCT Filed: Oct. 5, 2015
(86) PCT No.: PCT/EP2015/072903

§ 371 Date: Apr. 6, 2017

(30) Foreign Application Priority Data
Oct. 15, 2014 (EP) 14188949.3

(51) Int. Cl. H02K 1/32; H02K 3/24

(52) U.S. Cl. CPC H02K 1/32; H02K 3/24

(57) ABSTRACT

A rotor body for a rotor of a rotating electrical machine, having a plurality of rotor teeth which are arranged in a manner distributed over the circumference and run in an axial manner, axially running receiving slots for receiving in each case one conductor section of a rotor winding of the rotor being arranged between the rotor teeth. At least one slot is arranged on at least one radial side wall of at least one rotor tooth, the slot having at least one axial slot section, which extends from an end side of the rotor body at least partially axially over a prespecified subsection of the rotor body, and at least one radial slot section, which is connected to the axial slot section so as to communicate with it and extends from the axial slot section at least partially radially to an outer casing surface of the rotor body.

### CROSS REFERENCE TO RELATED APPLICATIONS

This application is the US National Stage of International Application No. PCT/EP2015/072903 filed Oct. 5, 2015, and claims the benefit thereof. The International application claims the benefit of European Application No. EP14188949 filed Oct. 15, 2014. All of the applications are incorporated by reference herein in their entirety.

### FIELD OF INVENTION

The invention relates to a rotor body for a rotor of a rotating electrical machine, having a plurality of axially extending rotor teeth, arranged in a circumferentially distributed manner, between which are arranged axially extending locating slots for accommodating in each case a conductor section of a rotor winding of the rotor.

Furthermore, the invention relates to a rotating electrical machine, especially to a turbogenerator, having a stator and a rotor with at least one rotor body.

### BACKGROUND OF INVENTION

A rotating electrical machine comprises a stator and a rotatably mounted rotor. The rotor can have a rotor body with axial locating slots in which is arranged in each case a conductor section of a rotor winding of the rotor. The conductor sections which are arranged in the locating slots are interconnected in an electrically conducting manner on the end face outside the rotor body via transverse conductor sections which form in each case a rotor winding overhang on axially oppositely disposed sides of the rotor body.

For its mechanical support, a rotor winding overhang can be at least partially enclosed by a further rotor component, for example by a rotor cap. As a result of this, the effect of the rotor winding overhang being deformed during an operation of a rotating electrical machine on account of centrifugal forces acting upon it in the process can be prevented.

In order to cool a rotor winding overhang, it is known to introduce cooling passages in rotor teeth of a rotor body, which cooling passages, starting from an axial face end of the rotor body, first extend axially and then bend radially outward in order to be able to discharge a cooling fluid, which flows in the respective cooling passage, from the rotor body radially to the outside.

### SUMMARY OF INVENTION

It is an object of the invention to provide a more effective cooling of an overhang of a rotor of a rotating electrical machine.

The rotor body according to the invention for a rotor of a rotating electrical machine comprises a plurality of axially extending rotor teeth, arranged in a circumferentially distributed manner, between which are arranged axially extending locating slots for accommodating in each case a conductor section of a rotor winding of the rotor, wherein at least one groove is arranged on at least one radial sidewall of at least one rotor tooth, which groove has at least one groove section which extends at least partially axially from an end face of the rotor body over a predetermined sub-section of the rotor body, and has at least one radial groove section which is connected in a communicating manner to the axial groove section and extends at least partially radially from the axial groove section toward an outer shell surface of the rotor body.

According to the invention, instead of a conventional axial and central tooth hole on a rotor tooth, the groove is arranged on the radial end face of the rotor tooth, which groove, together with a wall section of a radial sidewall of a conductor section which is arranged in the locating slot adjacent to the groove or together with an electrical insulation which is arranged thereon, forms a cooling passage for the conducting of a cooling fluid. According to the invention, therefore, there is no need for a conventional axial tooth hole to be introduced centrally into a region of the rotor tooth which is mechanically highly stressed during operation of a rotating electrical machine, which would be accompanied by a mechanical weakening of the rotor tooth and consequently by a limitation of the possible geometry of the rotor tooth or of the locating slots which are arranged adjacent thereto. The limitation of the possible geometry of the rotor tooth or of the locating slots which are arranged adjacent thereto would in turn be accompanied by a limitation of the conductivity of a correspondingly equipped rotor. Moreover, the arrangement of the groove on the radial side face of the rotor tooth is considerably more cost effective and less risky in respect to production engineering with regard to damage of the rotor tooth or of the rotor body.

A cooling fluid, which is conducted through a cooling passage which is formed by the groove and a section of the radial sidewall of the conductor section which is arranged in a locating slot which is arranged adjacent to the groove, according to the invention comes directly into contact with the conductor section or with the electrical insulation which is arranged thereon, as a result of which a more effective cooling of the conductor section is provided than when using a conventional axial tooth hole in which the cooling fluid comes into direct contact exclusively with the rotor tooth and therefore only indirectly cools an adjacent conductor section.

A flow of cooling fluid through the groove or through a cooling passage formed therewith is created by centrifugal forces which act upon the cooling fluid in the cooling passage during operation of a correspondingly equipped rotating electrical machine. In addition, a blower can be connected upstream or downstream in order to provide an optimum volumetric flow of cooling fluid through the groove for cooling a rotor winding overhang.

Two or more corresponding grooves can also be arranged on the radial sidewall of the rotor tooth. The at least one groove can also have two or more axial groove sections and/or radial groove sections. In particular, two or more axial groove sections, which are arranged in a radially spaced apart manner, can be connected in a communicating manner to a single radial groove section. Alternatively, a single axial groove section can be connected in a communicating manner to two or more radial groove sections which are arranged in an axially spaced apart manner.

At least one corresponding groove can also be arranged on both radial side faces of a rotor tooth in each case. Moreover, a corresponding groove can be arranged on one or both radial sidewalls of each rotor tooth in each case in order to achieve maximum cooling of a rotor winding overhang.

The axial groove section can be connected to the radial groove section in a communicating manner at an angle or via a rounding. The latter is accompanied by a lower flow resistance of the groove, which enables a larger volumetric flow of cooling fluid through the groove or through a cooling passage which is formed therewith, which in turn makes a more effective cooling of a rotor winding overhang possible.

The rotating electrical machine can be a turbogenerator, for example.

The predetermined sub-section of the rotor body is advantageously shorter in design than half an axial length of the rotor body. As a result of this, a cooling fluid, which has already absorbed heat during the cooling of a winding overhang which is located upstream of the rotor body on the end face, can be discharged from the rotor body. As a result, the effect of the heat which is absorbed by the cooling fluid being disadvantageously introduced into the rotor body and into the conductor sections which are arranged thereon can be prevented. Moreover, the cooling effect of a correspondingly heated cooling fluid with regard to a cooling of the rotor body and of the conductor sections which are arranged on this is very limited, which obviates an arrangement of the groove on a sub-section of the rotor body which is longer than half the axial length of the rotor body. The predetermined sub-section of the rotor body, on which the groove is arranged, can be shorter in design than a third, a quarter or a fifth of the axial length of the rotor body, or even shorter.

The groove is advantageously arranged on a radially outer wall half of the radial sidewall of the rotor tooth. As a result of this, the cooling fluid, which flows into the groove or into a cooling passage, which is formed therewith, on an end face of the rotor body, can be conducted along the conductor sections, which are arranged in this radially outer region, of a winding overhang which is mounted upstream of the rotor body on the end face, in order to be able to optimally cool the winding overhang. The groove can be arranged on a radially outer third of the sidewall of the rotor tooth or even further radially on the outside.

The groove is advantageously at least partially of circle segment-like design in cross section. This, in comparison to a polygonal cross section of the groove, is accompanied by lower vortices of a cooling fluid which flows through the groove or through a cooling passage which is formed therewith and is therefore accompanied by a lower flow resistance of the groove. As a result of this, a larger volumetric flow of cooling fluid can flow through the groove or through the cooling passage formed therewith, which enables a more effective cooling of a rotor winding overhang. The axial groove section and/or the radial groove section can be at least partially of circle segment-like design in cross section. Alternatively, the groove can be at least partially of semicircular design, otherwise of rounded or polygonal design in cross section.

Advantageously, at least one groove section extends rectilinearly. This embodiment is also accompanied by a reduction of the flow resistance of the groove, as a result of which a larger volumetric flow of cooling fluid can flow through the groove or through a cooling passage formed therewith, which enables a more effective cooling of a rotor winding overhang. Both the axial and the radial groove sections can also extend rectilinearly.

The rotating electrical machine according to the invention, especially a turbogenerator, comprises a stator and a rotor with at least one rotor body, wherein the rotor body is designed according to one of the aforesaid embodiments or according to an optional combination of the same.

The advantages which are mentioned above with regard to the rotor body are correspondingly associated with the rotating electrical machine.

An embodiment of the rotor body according to the invention is explained below with reference to the attached schematic drawing.

### BRIEF DESCRIPTION OF THE DRAWINGS

In the drawing:

FIG. 1 shows a schematic and perspective view of a detail of an exemplary embodiment for a rotor body according to the invention.

### DETAILED DESCRIPTION OF INVENTION

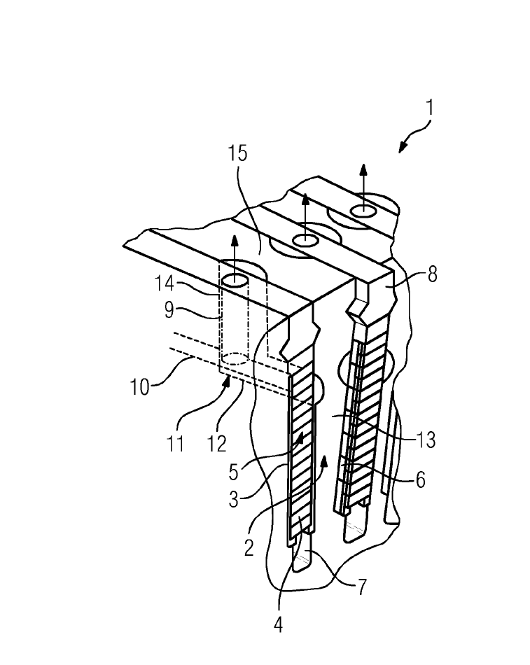

FIG. 1 shows a schematic and perspective view of a detail of an exemplary embodiment for a rotor body 1 according to the invention for rotor, not shown more extensively, of a rotating electrical machine.

The rotor body 1 comprises a plurality of axially extending rotor teeth 2, arranged in a circumferentially distributed manner, between which are arranged axially extending locating slots 3 for accommodating a conductor section 5, formed in each case by a plurality of conductor elements 4, of a rotor winding, not shown more extensively, of the rotor. The conductor sections 5 are shown in section. The conductor sections continue further to the right in FIG. 1, forming a rotor winding overhang to be cooled, not shown, of the rotor which for reasons of clarity is not shown in more detail. Each conductor section 5 is enclosed by an electrical insulation 6 which is also arranged between the conductor elements 4.

Radially on the inside, each locating slot 3 comprises a slot base channel 7 through which a cooling fluid can be conducted for cooling the conductor section 5 which is arranged in the locating slot 3 in each case. Each locating slot 3 is closed off radially on the outside by a slot wedge 8 in each case. Arranged on each slot wedge 8 is at least one radial hole 9 through which a cooling fluid, which is conducted through an axial cooling passage 10 on the respective conductor section 5, can be directed radially to the outside.

At least one groove 11 is arranged on each radial sidewall of each rotor tooth 2, wherein the groove 11 is arranged on a radially outer wall half of the radial sidewall of the respective rotor tooth 2. The groove 11 comprises a rectilinearly extending axial groove section 12 which extends axially from an end face 13 of the rotor body 1 over a predetermined sub-section of the rotor body 1. Furthermore, the groove 11 comprises a rectilinearly extending radial groove section 14 which is connected in a communicating manner to the axial groove section 12 and extends from the axial groove section 12 radially toward an outer shell surface 15 of the rotor body 1. The predetermined sub-section of the rotor body 1 is of considerably shorter design than a quarter of an axial length of the rotor body 1. The groove sections 12 and 14 are of circle segment-like design in cross section.

Although the invention has been fully illustrated and described in detail by means of the preferred exemplary embodiment, the invention is not thereby limited by the disclosed example and other variations can be derived by the person skilled in the art without departing from the extent of protection of the invention.

1. A rotor body for a rotor of a rotating electrical machine, comprising:
a plurality of axially extending rotor teeth, arranged in a circumferentially distributed manner, between which are arranged axially extending locating slots for accommodating in each case a conductor section of a rotor winding of the rotor,
wherein at least one groove is arranged on at least one radial sidewall of at least one rotor tooth, which groove has at least one groove section which extends at least partially axially from an end face of the rotor body over a predetermined sub-section of the rotor body, and has at least one radial groove section which is connected in a communicating manner to the axial groove section and extends at least partially radially from the axial groove section toward an outer shell surface of the rotor body.

2. The rotor body as claimed in claim 1,
wherein the predetermined sub-section of the rotor body is shorter than half an axial length of the rotor body.

3. The rotor body as claimed in claim 1,
wherein the groove is arranged on a radially outer wall half of the radial sidewall of the rotor tooth.

4. The rotor body as claimed in claim 1,
wherein the groove is at least partially of circle segment-like design in cross section.

5. The rotor body as claimed in claim 1,
wherein at least one groove section extends rectilinearly.

6. A rotating electrical machine, comprising:
a stator and a rotor with at least one rotor body
wherein the rotor body is as claimed in claim 1.

7. The rotating electrical machine of claim 6,
wherein the rotating electrical machine is a turbogenerator.
